(19) United States
(12) Patent Application Publication
(10) Pub. No.: US 2023/0119669 A1
(43) Pub. Date: Apr. 20, 2023

(54) WIRING MEMBER

(71) Applicant: Sumitomo Wiring Systems, Ltd., Yokkaichi-shi, Mie (JP)

(72) Inventors: Hironobu YAMAMOTO, Yokkaichi-shi, Mie (JP); Kyungwoo KIM, Yokkaichi-shi, Mie (JP); Toshinari KOBAYASHI, Yokkaichi-shi, Mie (JP); Yukitioshi TERASAKA, Yokkaichi-shi, Mie (JP)

(21) Appl. No.: 17/759,615

(22) PCT Filed: Jan. 12, 2021
(86) PCT No.: PCT/JP2021/000640

§ 371 Date: Jul. 27, 2022

(30) Foreign Application Priority Data
Jan. 28, 2020 (JP) 2020-011468

(51) Int. Cl. B60R 16/02; H01B 7/40; H02G 3/04; H01B 7/18; H02G 3/30

(52) U.S. Cl. CPC B60R 16/0215; H01B 7/40; H02G 3/0406; H01B 7/18; H02G 3/30

(57) ABSTRACT

A wiring member is an undercarriage wiring member that connects a vehicle body-side device and a wheel-side device to each other, the wiring member including: a first electric wire group; a second electric wire group that extends along the first electric wire group at least in a certain section; and a plurality of holding members each including a first holding portion and a second holding portion, wherein each of the plurality of holding members holds the first electric wire group in the first holding portion, and the second electric wire group in the second holding portion, and the plurality of holding members are provided at intervals along a path of a parallel section in which the first electric wire group and the second electric wire group are parallel with each other.

### CROSS-REFERENCE TO RELATED APPLICATIONS

This application is the U.S. national stage of PCT/JP2021/000640 filed on Jan. 12, 2021, which claims priority of Japanese Patent Application No. JP 2020-011468 filed on Jan. 28, 2020, the contents of which are incorporated herein.

### TECHNICAL FIELD

The present disclosure relates to a wiring member.

### BACKGROUND ART

JP 2016-91731A discloses a harness for housing an ABS sensor cable and a parking brake cable in a sheath. With the harness disclosed in JP 2016-91731A, a plurality of undercarriage electric wires that connect a vehicle body-side device and a wheel-side device to each other can be collectively handled.

There is demand for making it easier to collectively handle a large number of electric wires in an undercarriage wiring member for a vehicle.

Therefore, the present disclosure aims to provide a technology for making it easier to collectively handle a large number of electric wires in an undercarriage wiring member for a vehicle.

### SUMMARY

A wiring member according to the present disclosure is an undercarriage wiring member that connects a vehicle body-side device and a wheel-side device to each other, the wiring member including: a first electric wire group; a second electric wire group that extends along the first electric wire group at least in a certain section; and a plurality of holding members each including a first holding portion and a second holding portion, wherein each of the plurality of holding members holds the first electric wire group in the first holding portion, and the second electric wire group in the second holding portion, and the plurality of holding members are provided at intervals along a path of a parallel section in which the first electric wire group and the second electric wire group are parallel with each other.

### Advantageous Effects

The present disclosure makes it easier to collectively handle a large number of electric wires in an undercarriage wiring member for a vehicle.

### BRIEF DESCRIPTION OF DRAWINGS

FIG. 1 is a schematic plan view showing a wiring member according to a first embodiment.

FIG. 2 is a partially enlarged perspective view showing the wiring member according to the first embodiment.

FIG. 3 is a cross-sectional view taken along a II-II line shown in FIG. 1.

FIG. 4 is a schematic plan view showing a state in which the wiring member is attached to a vehicle.

FIG. 5 is a partially enlarged schematic perspective view showing a state in which the wiring member is attached to a vehicle.

FIG. 6 is a schematic cross-sectional view showing a wiring member according to a second embodiment.

### DETAILED DESCRIPTION OF PREFERRED EMBODIMENTS

First, embodiments of the present disclosure will be listed and described.

A wiring member according to the present disclosure is as follows.

### First Aspect

An undercarriage wiring member according to a first aspect connects a vehicle body-side device and a wheel-side device to each other, the wiring member includes: a first electric wire group; a second electric wire group that extends along the first electric wire group at least in a certain section; and a plurality of holding members each including a first holding portion and a second holding portion, wherein each of the plurality of holding members holds the first electric wire group in the first holding portion, and the second electric wire group in the second holding portion, and the plurality of holding members are provided at intervals along a path of a parallel section in which the first electric wire group and the second electric wire group are parallel with each other. As a result of a plurality of holding members are provided at intervals along the path of the parallel section to hold the first electric wire group and the second electric wire group, which makes it easier to collectively handle a large number of electric wires in the undercarriage wiring member for a vehicle.

### Second Aspect

In a second aspect, the wiring member according to the first aspect, the plurality of holding members may be insert-molded members into which the first electric wire group and the second electric wire group are inserted. With this configuration, it is easier to match the shape of each holding member with the shapes of the first electric wire group and the second electric wire group.

### Third Aspect

In a third aspect, the wiring member according to the first and second aspect may further include a vehicle attachment portion that is provided on at least one of the plurality of holding members. With this configuration, the wiring member can be fixed to the vehicle at the position of at least one holding member.

### Fourth Aspect

In a fourth aspect, the wiring member according to any one of the first to the third aspects, the first holding portion and the second holding portion may hold the first electric wire group and the second electric wire group with an interval therebetween in a parallel direction. With this configuration, the first electric wire group and the second electric wire group are prevented from rubbing against each other.

### Fifth Aspect

In a fifth aspect, the wiring member according to any one of the first to the fourth aspects, the first electric wire group and the second electric wire group may each be a cable that includes a plurality of coated electric wires and a sheath that covers the plurality of coated electric wires. With this configuration, when attaching the holding members to the first electric wire group and the second electric wire group, it is easier to handle the first electric wire group and the second electric wire group.

Specific examples of a wiring member according to the present disclosure will be described with reference to the drawings. Note that the present disclosure is not limited to these examples, but is shown by the scope of claims, and is intended to include all modifications within the meaning and scope equivalent to the scope of claims.

### First Embodiment

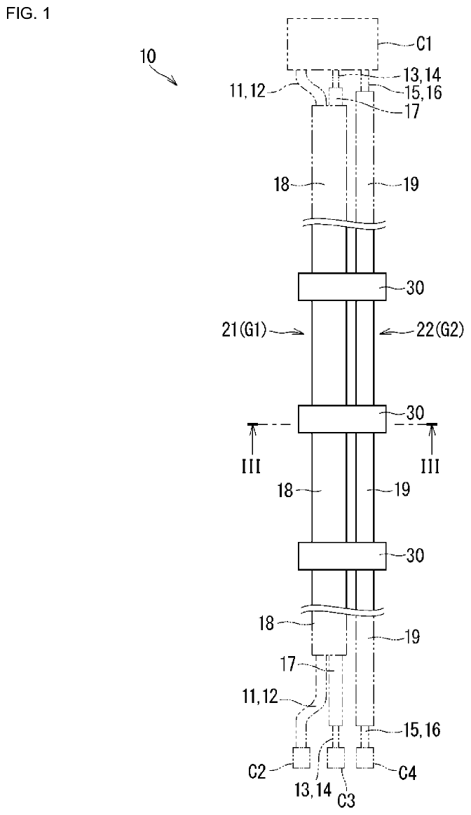

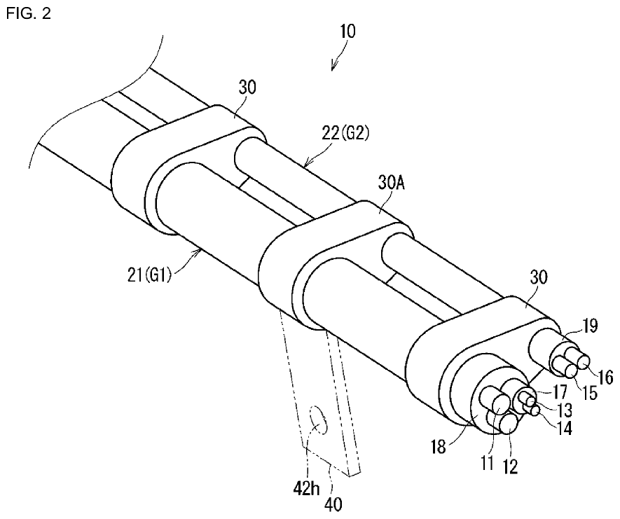

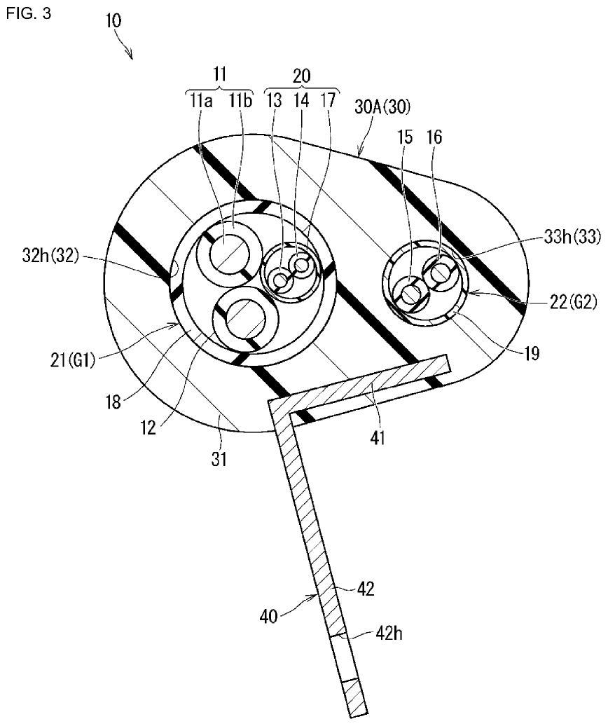

The following describes a wiring member according to the first embodiment. FIG. 1 is a schematic plan view showing a wiring member 10 according to the first embodiment. FIG. 2 is a partially enlarged perspective view showing the wiring member 10 according to the first embodiment. FIG. 3 is a cross-sectional view taken along the II-II line shown in FIG. 1.

The wiring member 10 is an undercarriage wiring member 10 for a vehicle. The wiring member 10 connects a vehicle body-side device and a wheel-side device in the vehicle. One end portion of the wiring member 10 in the lengthwise direction thereof is connected to the vehicle body-side device. The other end portion of the wiring member 10 in the lengthwise direction thereof is connected to the wheel-side device. The wiring member 10 includes a first electric wire group G1, a second electric wire group G2, and a plurality of holding members 30. The second electric wire group G2 extends along the first electric wire group G1 at least in a certain section. The wiring member 10 further includes a vehicle attachment portion 40.

The first electric wire group G1 includes one or more electric wires. The second electric wire group G2 includes one or more electric wires. In this example, the first electric wire group G1 includes four electric wires 11, 12, 13, and 14, and the second electric wire group G2 includes two electric wires 15 and 16. As shown in FIG. 3, the electric wire 11 is a coated electric wire that includes a core wire 11a and a coating layer 11b that covers the core wire 11a. The core wire 11a includes one or more strands. The strands are made of a conductive material such as copper, a copper alloy, aluminum, an aluminum alloy, or the like. The coating layer 11b is made of an insulating material such as resin. The coating layer 11b is formed by extruding an insulating material around the core wire 11a or by baking an insulating material after application. As with the electric wire 11, the other electric wires 12, 13, 14, 15, and 16 are also coated electric wires that each have a core wire and a coating layer covering the core wire. The electric wires 11, 12, 13, 14, 15, and 16 are each a single-core electric wire that forms one conductive path.

In the electric wire groups G1 and G2 including the plurality of electric wires 11, 12, 13, 14, 15, and 16, the plurality of electric wires 11, 12, 13, 14, 15, and 16 may be bundled. The member that bundles the plurality of electric wires 11, 12, 13, 14, 15, and 16 is not particularly limited, and may be a binding member such as a piece of adhesive tape or a zip tie, or a sheath. In this example, the plurality of electric wires 11, 12, 13, 14, 15, and 16 are bundled by sheaths 17, 18, and 19.

The first electric wire group G1 employs a cable (also referred to as a multi-core electric wire) that includes a plurality of coated electric wires and a sheath that covers the plurality of coated electric wires. Specifically, a sheath 17 is provided around the electric wires 13 and 14 so as to form a cable 20. A sheath 18 is provided around the electric wires 11 and 12 and the cable 20 so as to form a cable 21. The first electric wire group G1 includes a section that is constituted by the cable 21.

The second electric wire group G2 also employs a cable that includes a plurality of coated electric wires and a sheath that covers the plurality of coated electric wires. Specifically, a sheath 19 is provided around the electric wires 15 and 16 so as to form a cable 22. The second electric wire group G2 includes a section that is constituted by the cable 22. A parallel section in which the first electric wire group G1 and the second electric wire group G2 are parallel with each other is provided at the section in which the first electric wire group G1 and the second electric wire group G2 are constituted by the cables 21 and 22, respectively.

End portions of the plurality of electric wires 11, 12, 13, 14, 15, and 16 are connected to a vehicle body-side device such as an ECU (Electronic Control Unit). The end portions of the plurality of electric wires 11, 12, 13, 14, 15, and 16 may be connected to the same vehicle body-side device or different vehicle body-side devices. In the example shown in FIG. 1, the end portions of the first electric wire group G1 and the second electric wire group G2 are housed in the same connector housing so as to form a single connector C1. The end portions of the first electric wire group G1 and the second electric wire group G2 may be housed in different connector housings so as to form different connectors.

The opposite end portions of the plurality of electric wires 11, 12, 13, 14, 15, and 16 are connected to a wheel-side device. Examples of such a wheel-side device include actuator-type devices such as an EPB (Electric Parking Brake) and an EMB (Electromechanical Brake), and sensor-type devices such as a wheel speed sensor for an ABS (Antilock Brake System). The plurality of electric wires 11, 12, 13, 14, 15, and 16 may be used as power lines or signal lines (communication lines). Power lines are electric wires for driving actuator-type devices. Signal lines are electric wires for transmitting, for example, a device control signal or a signal related to the result of a measurement performed by a sensor-type device. Generally, the value of currents flowing through power lines is larger than the value of currents flowing through signal lines, and therefore the diameter of power lines is larger than the diameter of signal lines. For example, the electric wires 11 and 12 are power lines. The opposite end portions of the electric wires 11 and 12 are housed in the same connector housing so as to form a single connector C2. The connector C2 is connected to an EPB. The electric wires 13 and 14 are signal lines. The opposite end portions of the electric wires 13 and 14 are housed in the same connector housing so as to form a single connector C3. The connector C3 is connected to a sensor head of an ABS sensor (a wheel speed sensor). The electric wires 15 and 16 are signal lines. The opposite end portions of the electric wires 15 and 16 are housed in the same connector housing so as to form a single connector C4. The connector C4 is connected to a sensor other than the wheel speed sensor.

In the present description, electric wires for one wheel-side device are regarded as a single electric wire set. A plurality of electric wire sets are divided into a plurality of electric wire groups. The electric wire groups G1 and G2 each include one or more electric wire sets. The number of electric wire sets is greater than the number of electric wire groups. In this case, there is at least one electric wire group that includes a plurality of electric wire sets. In the example shown in FIG. 3, the wiring member 10 includes three electric wire sets, namely an electric wire set that includes the electric wires 11 and 12, an electric wire set that includes the electric wires 13 and 14, and an electric wire set that includes the electric wires 15 and 16. The three electric wire sets are divided between the two electric wire groups G1 and G2. The first electric wire group G1 includes two electric wire sets, namely the electric wire set that includes the electric wires 11 and 12 and the electric wire set that includes the electric wires 13 and 14. The second electric wire group G2 includes one electric wire set that includes the electric wires 15 and 16. How the electric wire sets are divided, i.e., which electric wire sets are to be combined in one electric wire group, is appropriately determined according to the types of devices, the electric wire path, and the like. However, the number of electric wire sets and the number of electric wire groups may be the same. Also, a plurality of electric wires connected to the same wheel-side device may be arranged separately in different electric wire groups.

One end portion of the wiring member 10 in the lengthwise direction thereof is located in the interior of the vehicle. The opposite end portion of the wiring member 10 in the lengthwise direction thereof is located on the exterior of the vehicle. Therefore, the wiring member 10 includes an intermediate portion that passes through the boundary between the interior and exterior areas. Usually, the boundary between the interior and exterior of the vehicle is a vehicle body panel. Through holes are formed in the vehicle body panel. The wiring member 10 is passed between the interior and exterior of the vehicle through the through holes. Grommets or the like (not shown) are provided on the portions of the wiring member 10 that pass through the through holes. The parallel section of the first electric wire group G1 and the second electric wire group G2 is provided at least in the outdoor area.

The plurality of holding members 30 each include a first holding portion 32 and a second holding portion 33. Each of the plurality of holding members 30 holds the first electric wire group G1 in the first holding portion 32, and the second electric wire group G2 in the second holding portion 33. The holding members 30 are not members consisting of a single piece of tape. Cases in which the holding members 30 are members consisting of a single piece of tape are excluded. Although three holding members 30 are provided in this example, the number of holding members 30 is not limited to three. The number of holding members 30 may be two, or four or more.

Each of the holding members 30 includes a main body 31. The main body 31 is constituted by two semi-cylindrical portions and a coupling portion that connects the semi-cylindrical portions. The two semi-cylindrical portions are sized according to the thickness of the first electric wire group G1 and the second electric wire group G2 (the thickness of the cables 21 and 22 in this example). One of the two semi-cylindrical portions covers the cable 21 and the other covers the cable 22. The two semi-cylindrical portions have the same wall thickness. Therefore, the diameter of the semi-cylindrical portion that covers the cable 21 is larger than the diameter of the semi-cylindrical portion that covers the cable 22. The two semi-cylindrical portions do not necessarily have to be formed in sizes corresponding to the thickness of the cables 21 and 22, respectively. For example, even if the cables 21 and 22 have different thicknesses, the two semi-cylindrical portions may have the same size. The outer surface of the coupling portion is a flat surface. Therefore, as shown in FIG. 3, the outer surface of the coupling portion has a straight shape in a cross section. The outer surface of the coupling portion may be a surface that protrudes outward or a surface that is recessed inward.

The first electric wire group G1 and the second electric wire group G2 pass through the main body 31. Therefore, it can be considered that through holes are formed in the main body 31. The portions in which through holes are formed are the holding portions. In this example, a first through hole 32h and a second through hole 33h are formed in the main body 31. The first electric wire group G1 passes through the first through hole 32h. The portion in which the first through hole 32h is formed is the first holding portion 32. The second electric wire group G2 passes through the second through hole 33h. The portion in which the second through hole 33h is formed is the second holding portion 33.

The plurality of holding members 30 are insert-molded members into which the first electric wire group G1 and the second electric wire group G2 are inserted. The holding members 30 are made of a resin such as polyurethane. The inner surface of the main body 31 of each holding member 30 (the circumferential surfaces of the through holes 32h and 33h) and the outer surfaces of the electric wire groups G1 and G2 (the outer surfaces of the sheaths 18 and 19 in this example) are in surface contact with each other. The inner surface of the main body 31 of each holding member 30 and the outer surfaces of the electric wire groups G1 and G2 may or may not be joined. Whether or not they are to be joined is determined based on the combination of the material of each holding member 30 and the material of the outermost layers of the electric wire groups G1 and G2 (the sheaths 18 and 19 in this example), and the molding conditions such as the melting temperature of the resin material when each holding member 30 is molded.

Each holding member 30 may be rigid to the extent of being bendable. The first electric wire group G1 and the second electric wire group G2 may be bendable at the position of each holding member 30. Each holding member 30 may be rigid to the extent of being unbendable. The first electric wire group G1 and the second electric wire group G2 may be unbendable at the position of each holding member 30.

The dimension of each holding member 30 in the lengthwise direction of the first electric wire group G1 and the second electric wire group G2 (hereinafter referred to as a thickness dimension) is not particularly limited. For example, the thickness dimension of each holding member 30 may be 15 mm or more. Also, for example, the thickness dimension of each holding member 30 may be 30 mm or less.

The first holding portion 32 and the second holding portion 33 hold the first electric wire group G1 and the second electric wire group G2 with an interval therebetween in the parallel direction. Such an interval (hereinafter referred to as a first interval) is the interval between the closest portions of the first electric wire group G1 and the second electric wire group G2, and is an interval between the outer surfaces of the sheaths 18 and 19 in the example shown in FIG. 3. The first interval is not particularly limited, and may be set as necessary. For example, the first interval may be 100 mm or more. Also, for example, the first interval may be 200 mm or less. However, the first interval may be omitted. The first electric wire group G1 and the second electric wire group G2 may be in contact with each other. The first through hole 32h and the second through hole 33h may be continuous with each other.

The plurality of holding members 30 are provided at intervals along a path of the parallel section of the first electric wire group G1 and the second electric wire group G2. Such an interval (hereinafter referred to as a second interval) is the interval between the closest portions of holding members in a state where short electric wire groups are stretched in a straight line. In the example shown in FIG. 1, the second interval is larger than the thickness dimension of the holding members 30. However, the second interval is not particularly limited, and may be set as necessary. For example, the second interval may be the same as or smaller than the thickness dimension of the holding members 30. For example, the second interval may be 100 mm or more. Also, for example, the second interval may be 300 mm or less. Furthermore, if three or more holding members 30 are provided, the second intervals between adjacent sections may be the same or different.

The vehicle attachment portion 40 is provided on at least one of the plurality of holding members 30. In this example, a holding member 30A of the plurality of holding members 30 is not provided with the vehicle attachment portion 40. One or more holding members 30 of the plurality of holding members 30 are not provided with the vehicle attachment portion 40. All of the plurality of holding members 30 may be provided with the vehicle attachment portion 40. The vehicle attachment portion 40 may be a member molded separately from the holding members 30, such as a metal bracket. The vehicle attachment portion 40 may be made of the same material as the holding members 30 and molded integrally with the holding member 30 corresponding thereto. In the example shown in FIG. 3, the vehicle attachment portion 40 is an insert of the holding member 30 as with the electric wire groups G1 and G2. The vehicle attachment portion 40 may be separately attached to the holding member 30. The structure for attaching the vehicle attachment portion 40 to the holding member 30 is not particularly limited. For example, the structure for attaching the vehicle attachment portion 40 to the holding member 30 may employ crimping.

The vehicle attachment portion 40 includes a first attachment portion 41 and a second attachment portion 42. The first attachment portion 41 is a portion that is to be attached to the holding members 30. The second attachment portion 42 is a portion that is to be attached to the vehicle. In this example, the vehicle attachment portion 40 is a metal bracket formed in an L shape by bending a plate member at an intermediate position thereof. An end portion of the metal bracket is embedded in the holding member 30 as the first attachment portion 41. The end portion of the metal bracket is an insert when the holding member 30 is molded. The opposite end portion of the metal bracket protrudes outward from the holding member 30, as the second attachment portion 42. For example, a through hole 42h is formed in the opposite end portion of the metal bracket, and is fixed to the vehicle using a nut and bolt.

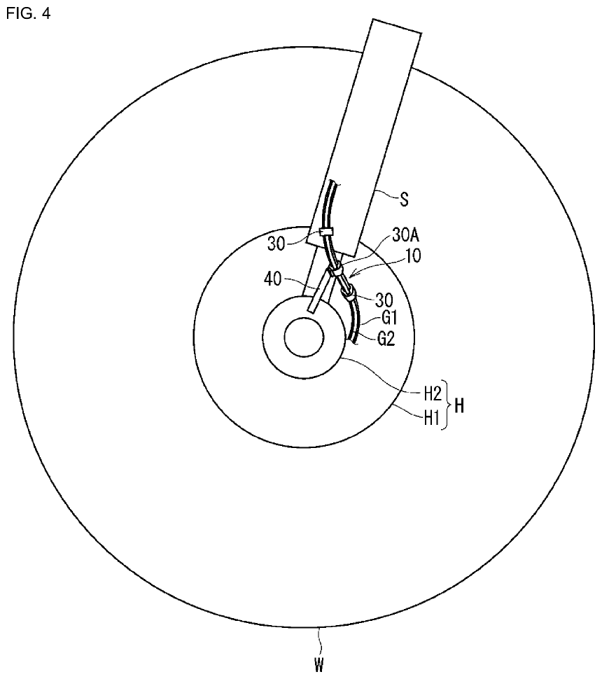

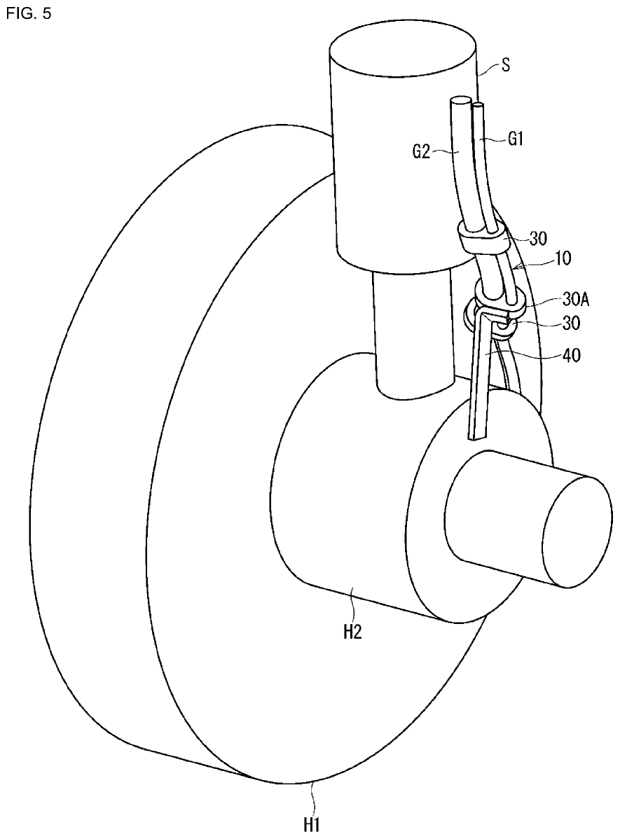

FIG. 4 is a schematic plan view showing a state in which the wiring member 10 is attached to a vehicle. FIG. 5 is a partially enlarged schematic perspective view showing a state in which the wiring member 10 is attached to a vehicle.

FIG. 4 shows an example of an undercarriage portion of the vehicle. A wheel W is supported by a suspension system so as to be able to rotate and swing up and down relative to a vehicle body frame. Such a suspension system includes, for example, a wheel hub unit H and a shock absorber S. The wheel hub unit H supports the wheel W so that the wheel W is rotatable. The wheel hub unit H includes a first member H1, a second member H2, and a bearing (not shown). The first member H1 and the second member H2 are coupled to each other using a bearing so as to be rotatable. The first member H1 is fixed to the wheel W and rotates together with the wheel W. The second member H2 supports the first member H1 with a bearing interposed therebetween so that the first member H1 is rotatable. The shock absorber S couples the vehicle body frame and the wheel hub unit H to each other. The shock absorber S supports the second member H2 so that the second member H2 is swingable. The vehicle attachment portion 40 in the wiring member 10 is fixed to the wheel hub unit H. The fixing structure between the vehicle attachment portion 40 and the wheel hub unit H is not particularly limited, and may employ screwing with nuts and bolts, for example.

In this example, the vehicle attachment portion 40 is fixed to the second member H2. Therefore, a portion of the wiring member 10 swings up and down. Therefore, the wiring member 10 is required to have flexibility to withstand swinging. If the plurality of electric wires 11, 12, 13, 14, 15, and 16 are combined in a single sheath, flexibility may deteriorate. In this example, the plurality of electric wires 11, 12, 13, 14, 15, and 16 are divided into two electric wire groups G1 and G2, and therefore a decrease in flexibility can be suppressed.

For example, a disc rotor, a sensor rotor, and the like are also attached to the wheel hub unit H. The disc rotor and the sensor rotor are attached to the first member H1 so as to rotate together with the wheel W.

A brake pad is applied to the disc rotor. The brake pad and the drive source therefor are supported by a brake caliper. The opposite end portions of the electric wires 11 and 12 for the EPB are connected to the brake caliper.

The opposite end portions of the electric wires 13 and 14 for the ABS sensor are connected to the sensor head of the wheel speed sensor. The sensor head of the wheel speed sensor may be provided integrally with the electric wires 13 and 14. The sensor head of the wheel speed sensor is positioned so as to face the sensor rotor to detect the rotation speed of the sensor rotor.

As shown in FIG. 4, the wiring member 10 may be routed in a bent state in the undercarriage portion of the vehicle. The wiring member 10 is bent in the section between the holding members 30. The components of bending include a component of bending in a direction orthogonal to the lengthwise direction and the parallel direction (the left-right direction in FIG. 3) of the electric wires. The components of bending may include a component of bending in the parallel direction of the electric wires. The difference between the paths of the plurality of electric wire groups G1 and G2 that occurs when the electric wires are bent in the parallel direction thereof is likely to be larger than the difference between the paths of the plurality of electric wire groups G1 and G2 that occurs when the electric wires are bent in the direction orthogonal to the lengthwise direction and the parallel direction thereof. Therefore, in the wiring member 10, it is likely that it will be more difficult to bend the electric wires in the parallel direction than to bend the electric wires in the direction orthogonal to the lengthwise direction and the parallel direction. If the holding members 30 and the electric wire groups G1 and G2 are movable in the lengthwise direction relative to each other, the difference of the paths can be absorbed by the holding members 30 and the electric wire groups G1 and G2 moving in the lengthwise direction relative to each other, and bending in the parallel direction can easily be handled. If the holding members 30 and the electric wire groups G1 and G2 are not easily movable in the lengthwise direction, it is preferable that the length dimension of the electric wire groups G1 and G2 between the holding members 30 is set in advance to be the length dimension corresponding to the difference of the paths caused when the electric wires are bent. If this is the case, in a state where the wiring member 10 extends straight, there may be a difference in the length dimensions of the electric wire groups G1 and G2 between the holding members 30. That is to say, between the holding members 30, one of the first electric wire group G1 and the second electric wire group G2 that is shorter than the other may extend straight, and the longer one may be bent.

### Advantageous Effects, Etc. Of First Embodiment

With the wiring member 10 configured as described above, a plurality of holding members 30 are provided at intervals along the path of the parallel section to hold the first electric wire group G1 and the second electric wire group G2, which makes it easier to collectively handle a large number of electric wires 11, 12, 13, 14, 15, and 16 in the undercarriage wiring member 10 for a vehicle. As a result, it is easier to perform work to attach the electric wires 11, 12, 13, 14, 15, and 16 for a plurality of circuits to the vehicle. In addition, it is easier to route the wiring member 10 in a bent state in the section between the holding members 30. Also, it is possible to employ electric wires with a simple configuration or existing electric wires as the electric wires included in the electric wire groups (the cables 21 and 22 in this example). As a result, it is possible to suppress an increase in costs involved in integrating a large number of electric wires into one set.

Also, the plurality of holding members 30 are insert-molded members into which the first electric wire group G1 and the second electric wire group G2 are inserted. Therefore, it is easier to match the shape of the holding members 30 with the shapes of the first electric wire group G1 and the second electric wire group G2.

Also, at least one of the plurality of holding members 30 is provided with a vehicle attachment portion 40, and therefore the wiring member 10 can be fixed to the vehicle at the position of at least one holding member 30.

Also, the first holding portion 32 and the second holding portion 33 hold the first electric wire group G1 and the second electric wire group G2 with an interval therebetween in the parallel direction. Therefore, the first electric wire group G1 and the second electric wire group G2 are prevented from rubbing against each other.

Also, the first electric wire group G1 and the second electric wire group G2 are present in the form of the cables 21 and 22 in the parallel section. Therefore, when attaching the holding members 30 to the first electric wire group G1 and the second electric wire group G2, it is easier to handle the first electric wire group G1 and the second electric wire group G2.

### Second Embodiment

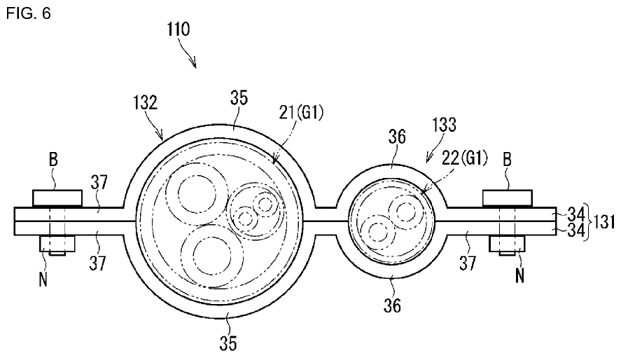

The following describes a wiring member according to a second embodiment. FIG. 6 is a schematic cross-sectional view showing a wiring member 110 according to the second embodiment. In the description of the present embodiment, the same components as those described so far are designated by the same reference numerals and the description thereof will be omitted.

In the wiring member 110 according to the second embodiment, the shape of holding members 130 is different from the shape of the holding members 30 according to the first embodiment. The holding members 130 are molded members molded separately from the electric wire groups G1 and G2. The holding members 130 are made of resin, metal, or the like. In the example shown in FIG. 6, a main body 131 of each holding member 130 includes two half-split members 34. Each half-split member 34 includes a first semi-cylindrical portion 35 and a second semi-tubular portion 36. The first semi-cylindrical portion 35 is formed in a semi-tubular shape corresponding to the size of the first electric wire group G1. The second semi-tubular portion 36 is formed in a semi-tubular shape corresponding to the size of the second electric wire group G2. The two half-split members 34 are combined into the main body 131. Two first semi-tubular portions 35 are combined into a first holding portion 132 that has a tubular shape. Two second semi-tubular portions 36 are combined into a second holding portion 133 that has a tubular shape. The two half-split members 34 are formed into the same shape. The two half-split members 34 may be formed into different shapes.

The two half-split members 34 are formed so as to be separate. The two half-split members 34 may be formed into a shape in which the half-split members 34 are coupled to each other so as to be rotatable about a hinge at one side edge.

When each holding member 130 is a molded member molded separately from the electric wire groups G1 and G2, the wiring member 110 may further include attachment maintaining portions. The attachment maintaining portions are portions for maintaining a state in which the holding member 130 is attached to the electric wire groups G1 and G2. In the example shown in FIG. 6, attachment maintaining portions are a bolt B and a nut N. Specifically, each half-split member 34 includes flanges 37. The flanges 37 are provided at two end portions. Each flange 37 is provided with an insertion hole through which a bolt B is to be inserted.

Each attachment maintaining portion may be constituted by members other than a bolt B or a nut N. For example, each attachment maintaining portion may be constituted by a locking piece and a locking recess that are molded integrally with a holding member 130. One of the two half-split members 34 is provided with a locking piece, and the other is provided with a locking recess. The locking piece is locked into the locking recess, and thus the two half-split members 34 are maintained in a combined state. Alternatively, for example, each attachment maintaining portion may be an adhesive or a piece of adhesive tape.

Although the first holding portion 132 and the second holding portion 133 are each constituted by the half-split members 34, such a configuration is not essential. The first holding portion and the second holding portion may each be constituted by a single member. For example, it is preferable that the first holding portion and the second holding portion are each provided with opening in a portion thereof in the circumferential direction, and are formed in a partial tubular shape subtending an angle larger than 180 degrees. If this is the case, the first holding portion and the second holding portion may be elastically deformable so that the openings thereof can be expanded. With this configuration, the openings are elastically deformed so as to expand, and the electric wire groups G1 and G2 are inserted into the first holding portion and the second holding portion. Thereafter, the openings are elastically restored, so that the electric wire groups G1 and G2 are held by the first holding portion and the second holding portion.

### Advantageous Effects, Etc. Of Second Embodiment

With the wiring member 110 configured as described above, the same advantageous effects as those of the wiring member 10 can be obtained as well, except the advantageous effects achieved by the fact that the holding members are insert-molded members. In the wiring member 110, the holding members 130 are not insert-molded members. Therefore, the holding members 130 that are molded separately from the electric wire groups G1 and G2 are attached to the electric wire groups G1 and G2.

### Modifications

Although the holding members 30 are described as being provided with the vehicle attachment portion 40, such a configuration is not essential. The holding members 30 do not necessarily have to be provided with the vehicle attachment portion 40. For example, a vehicle attachment portion may be provided on portions of the first electric wire group G1 and the second electric wire group G2 between the holding members 30.

The holding members 30 and 130 may hold three or more electric wire groups. If this is the case, it is preferable that the holding members each include three or more holding portions. For example, if the wiring member further includes a third electric wire group, it is preferable that the holding member further includes a third holding portion for holding the third electric wire group. For example, the third electric wire group may branch, and a holding member that holds all of the first, second, and third electric wire groups and a holding member that only holds the first and second electric wire groups may coexist. The positional relationship between the three or more holding portions is not particularly limited. For example, the three or more holding portions may be lined up in a row. Also, for example, the three or more holding portions may be arranged so that the figure connecting the centers of the holding portions forms a polygon.

It should be noted that the configurations described in the above embodiments and the modifications can be appropriately combined as long as they do not conflict with each other.

1. An undercarriage wiring member that connects a vehicle body-side device and a wheel-side device to each other, the wiring member comprising:
a first electric wire group;
a second electric wire group that extends along the first electric wire group at least in a certain section; and
a plurality of holding members each including a first holding portion and a second holding portion,
wherein each of the plurality of holding members holds the first electric wire group in the first holding portion, and the second electric wire group in the second holding portion, and
the plurality of holding members are provided at intervals along a path of a parallel section in which the first electric wire group and the second electric wire group are parallel with each other.

2. The wiring member according to claim 1, wherein the plurality of holding members are insert-molded members into which the first electric wire group and the second electric wire group are inserted.

3. The wiring member according to claim 1, further comprising a vehicle attachment portion that is provided on at least one of the plurality of holding members.

4. The wiring member according to claim 1, wherein the first holding portion and the second holding portion hold the first electric wire group and the second electric wire group with an interval therebetween in a parallel direction.

5. The wiring member according to claim 1, wherein the first electric wire group and the second electric wire group are each a cable that includes a plurality of coated electric wires and a sheath that covers the plurality of coated electric wires.

6. The wiring member according to claim 2, further comprising a vehicle attachment portion that is provided on at least one of the plurality of holding members.

7. The wiring member according to claim 2, wherein the first holding portion and the second holding portion hold the first electric wire group and the second electric wire group with an interval therebetween in a parallel direction.

8. The wiring member according to claim 3, wherein the first holding portion and the second holding portion hold the first electric wire group and the second electric wire group with an interval therebetween in a parallel direction.

9. The wiring member according to claim 2, wherein the first electric wire group and the second electric wire group are each a cable that includes a plurality of coated electric wires and a sheath that covers the plurality of coated electric wires.

10. The wiring member according to claim 3, wherein the first electric wire group and the second electric wire group are each a cable that includes a plurality of coated electric wires and a sheath that covers the plurality of coated electric wires.

11. The wiring member according to claim 4, wherein the first electric wire group and the second electric wire group are each a cable that includes a plurality of coated electric wires and a sheath that covers the plurality of coated electric wires.
